(19) United States
(12) Patent Application Publication
(10) Pub. No.: US 2025/0291565 A1
(43) Pub. Date: Sep. 18, 2025

(54) CODE AGILITY AND VISIBILITY VIA AUGMENTED DECISION-MAKING ALGORITHM

(71) Applicant: Kyndryl, Inc., New York, NY (US)

(72) Inventors: Kalpesh SHARMA, BANGALORE (IN); Reeth KUNJAPPA P, Bengaluru (IN); Nalini M, Chennai (IN); Veeresh BUSHETTI, Savanur (IN)

(21) Appl. No.: 18/602,617

(22) Filed: Mar. 12, 2024

(51) Int. Cl. G06F 8/60

(52) U.S. Cl. CPC G06F 8/60

(57) ABSTRACT

A computer-implemented method may include determining, by a computing device, a verve of a feature; determining, by a computing device, a first release intensity score (RIS) of the feature; stabilizing, by a computing device, a release train based on the verve and the RIS of the feature; and modifying, by a computing device, an engagement schedule based on the stabilized release train.

### BACKGROUND

Aspects of the present invention relate generally to stabilizing a code release and, more particularly, to systems and methods for the stabilized deployment and integration of code releases based on a determination of readiness.

Continuous deployment and integration of software, code features, or updates occur on a weekly, daily, or hourly basis. Readiness of deployment and integration of code releases determine successful code releases. A code release may include communicating features to a code repository. A code feature may be prepared and packaged as a release cut for distribution on, e.g., a weekly basis. Release cut features may be deployed to a staging environment where defects may be identified. Defected fixes may be prepared and released as required.

### SUMMARY

In a first aspect of the invention, there is a computer-implemented method including: determining, by a computing device, a verve of a feature; determining, by a computing device, a first release intensity score (RIS) of the feature; stabilizing, by a computing device, a release train based on the verve and the RIS of the feature; and modifying, by a computing device, an engagement schedule based on the stabilized release train.

In another aspect of the invention, there is a computer program product including one or more computer readable storage media having program instructions collectively stored on the one or more computer readable storage media. The program instructions are executable to: determine a verve of a feature; determine a first release intensity score (RIS) of the feature; stabilize a release train based on the verve and the RIS of the feature; and modify an engagement schedule based on the stabilized release train.

In another aspect of the invention, there is system including a processor, a computer readable memory, one or more computer readable storage media, and program instructions collectively stored on the one or more computer readable storage media. The program instructions are executable to: determine a verve of a feature; determine a first release intensity score (RIS) of the feature; stabilize a release train based on the verve and the RIS of the feature; and determine a mode of engagement and an engagement schedule based on the stabilized release train.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a block diagram of an exemplary environment in accordance with aspects of the invention.

FIG. 6 shows a block diagram of an exemplary system in accordance with aspects of the invention.

FIG. 7A shows a block diagram of an exemplary environment in accordance with aspects of the invention.

FIG. 7B shows a block diagram of an exemplary environment in accordance with aspects of the invention.

FIG. 8 shows a block diagram of an exemplary environment in accordance with aspects of the invention.

FIG. 9A shows a table of an exemplary method in accordance with aspects of the invention.

FIG. 9B shows a table of an exemplary method in accordance with aspects of the invention.

FIG. 9C shows a table of an exemplary method in accordance with aspects of the invention.

FIG. 9D shows a table of an exemplary method in accordance with aspects of the invention.

FIG. 9E shows a table of an exemplary method in accordance with aspects of the invention.

FIG. 9F shows a table of an exemplary method in accordance with aspects of the invention.

FIG. 10A shows a block diagram of an exemplary environment in accordance with aspects of the invention.

FIG. 10B shows a table of an exemplary method in accordance with aspects of the invention.

FIG. 10C shows a block diagram of an exemplary environment in accordance with aspects of the invention.

FIG. 10D shows a block diagram of an exemplary environment in accordance with aspects of the invention.

FIG. 11 shows a flowchart of an exemplary method in accordance with aspects of the invention.

FIG. 12 shows a flowchart of an exemplary method in accordance with aspects of the invention.

### DETAILED DESCRIPTION

Aspects of the present invention relate generally to systems and methods for the stabilized deployment and integration of code releases based on a determination of a verve, i.e., code feature readiness. Further, aspects of the present invention relate generally to systems and methods for generating a release schedule based on a determination of the verve of code for release and scheduling code for release based on verve packets. According to aspects of the present invention, the system may be configured to determine a release schedule for code based on its verve for deployment as well as its relative importance to the environment in which it is being deployed. In embodiments, the system may packetize code in a repository and schedule code deployment based on its verve as well as its relative importance to the environment in which it is being deployed. Relative importance may be measured by a release intensity score (RIS). RIS may be determined by estimating the required resources, timelines, and average or weighted average of all features within the release train. In embodiments, the system may include generating a user interface or digital dashboard indicating the verve of code packets in a particular release schedule. In this manner, implementations of the present invention stabilize release code cycles by determining code verve, determining an environment RIS, and configuring a release schedule based on the verve and the RIS.

Aspects of the present invention relate to methods for generating verve ratings in a code deployment environment. The method may include stabilizing code verve by releasing code in packets and stabilizing a release train or subjecting low-verve code back through the development framework to recalculate verve or RIS. The method may include gauging and gazing, e.g., measuring, monitoring, and observing, verve during the pre-release of code to determine the mode of engagement with a potential customer base.

In known systems, monitoring deployment and integration of software, code features, or updates from various sources requires high effort and may create system instability. Further, in known systems, tracking code release information from various sources to understand deployment information, velocity (the speed at which releases may be delivered), and risk associated with deployments is a laborious process. Accordingly, in known systems, stabilizing releases throughout deployment requires additional effort and resources when considering other factors relating to stable release. The additional effort and resources may include release prioritization, client prioritization, business prioritization, availability of resource bandwidth and third-party application integration, and release dependency, i.e., code release order where specific code portions, features, or functions are dependent on other code portions, features, or functions. Identifying risks associated with deployment also requires additional effort and resources and is reliant upon limited data associated with communicating code releases to code repositories, defect identification and testing, and defect repair fixes. In some instances within known systems, significant issues with code releases may be identified but unfixable within a release train timeline, resulting in code release withdrawal or a release being delayed.

Aspects of the present invention provide an improvement in a technical field of the invention by promoting continuous integration and deployment of software, code features, or updates while minimizing the risk associated with deployment by determining a verve and RIS for each software, code feature, or update, as well as associated release trains. Aspects of the present invention also stabilize the release of software, code features, or updates prior to deployment to achieve business objectives associated with the release by having correct content selections and speed of execution aligned with release content and its associated impact on development.

Aspects of the present invention are necessarily rooted in computer technology, e.g., determining and stabilizing of verve packets, which may include a machine learning model performing natural language processing (NLP) of external factors such as a release prioritization, a client prioritization, a business prioritization, availability of resource bandwidth and third-party application integration, and release dependency or generating and displaying a user interface element on a computing device indicating the verve of a plurality of code packets in the release train.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

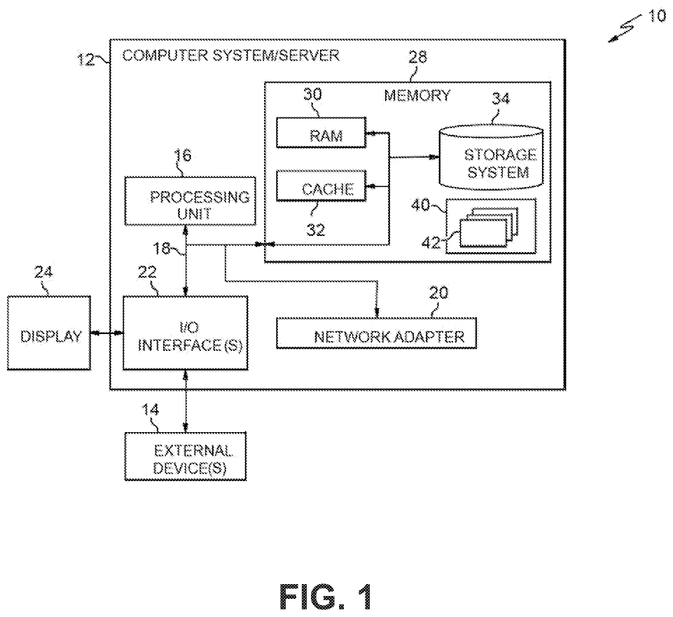

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

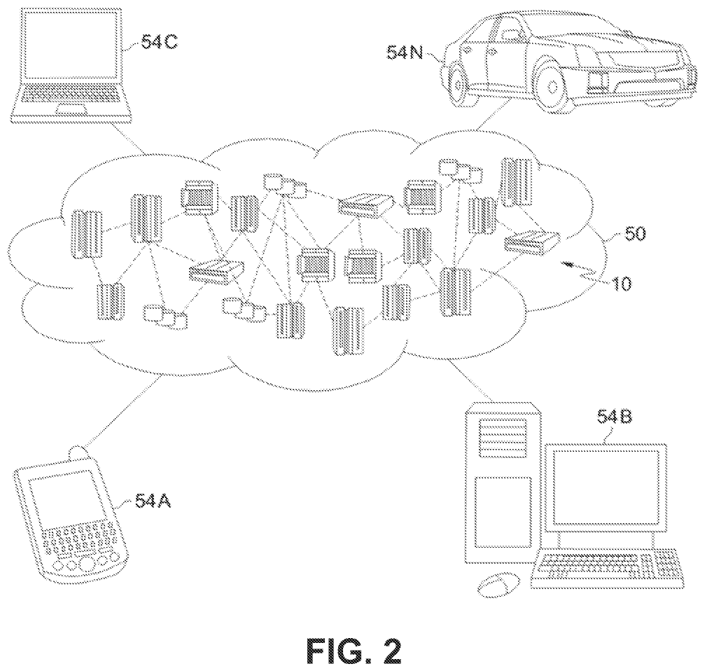

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

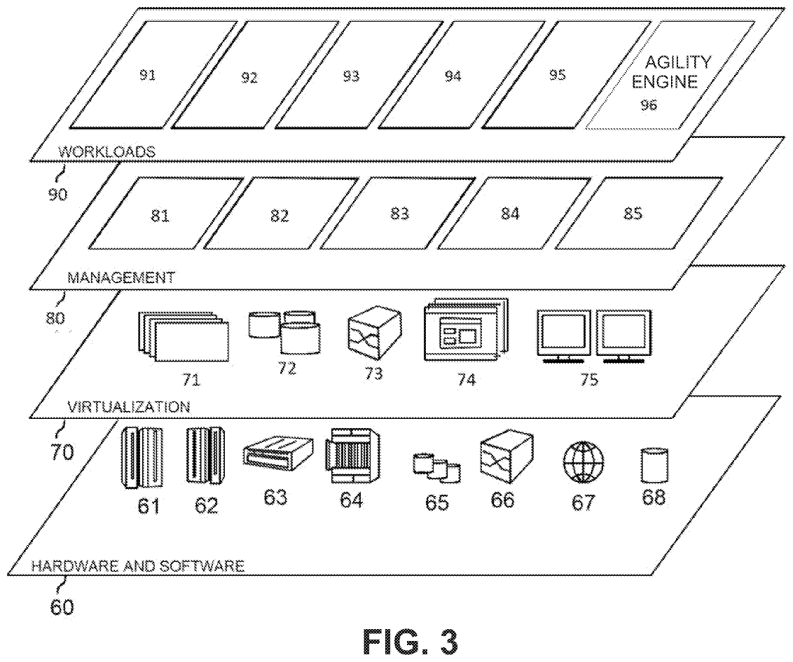

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and agility engine 96.

Implementations of the invention may include a computer system/server 12 of FIG. 1 in which one or more of the program modules 42 are configured to perform (or cause the computer system/server 12 to perform) one of more functions of the agility engine 96 of FIG. 3. For example, the one or more of the program modules 42 of the agility engine 96 may be configured to: determine verve of code releases, determine a release intensity score (RIS) for various code releases; stabilize a release train based on the verve and RIS; and modify an engagement schedule of code deployment based on the verve and RIS.

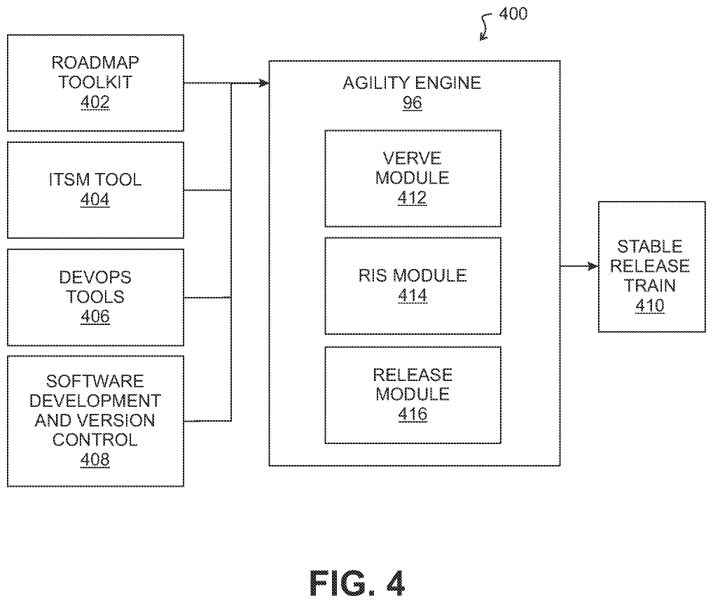

FIG. 4 shows a block diagram of an exemplary environment in accordance with aspects of the invention. In embodiments, the environment 400 includes agility engine 96 of FIG. 3. Agility engine 96 may receive development process information from development roadmap toolkit 402, information technology service management (ITSM) tools 404, development operations (DEVOPS) tools 406, and software development and version control 408. Agility engine 96 may be configured to determine and output a stable release train 410 based on the verve of code releases, a release intensity score (RIS) for various code releases, and a stabilized release train based on the verve and RIS. A mode of engagement and a modified engagement schedule of code deployment may be generated based on the verve and RIS.

In embodiments, the agility engine 96 comprises verve module 412, RIS module 414, and release module 416, each of which may comprise one or more program modules such as program modules 42 described with respect to FIG. 1. The verve module 412 performs verve determination and stabilization, which may include a via a machine learning model performing NLP of external factors such as a release prioritization, a client prioritization, a business prioritization, availability of resource bandwidth and third-party application integration, and release dependency. Verve determination may include identifying code release timing, resource availability, completeness of features, as well as its relative importance to the environment in which the features may be being deployed. Similarly, the verve module 412 may stabilize release trains based on the verve and RIS. RIS module 414 may determine RIS on verve packets or groups of verve packets having similar RIS. Release module 416 may modify modes of engagement and engagement schedules and release trains based on the verve and the RIS, as well as determining a mode of engagement based on the verve, such as gauging and gazing the verve to determine which modes of engagement are appropriate for a particular feature. The agility engine 96 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

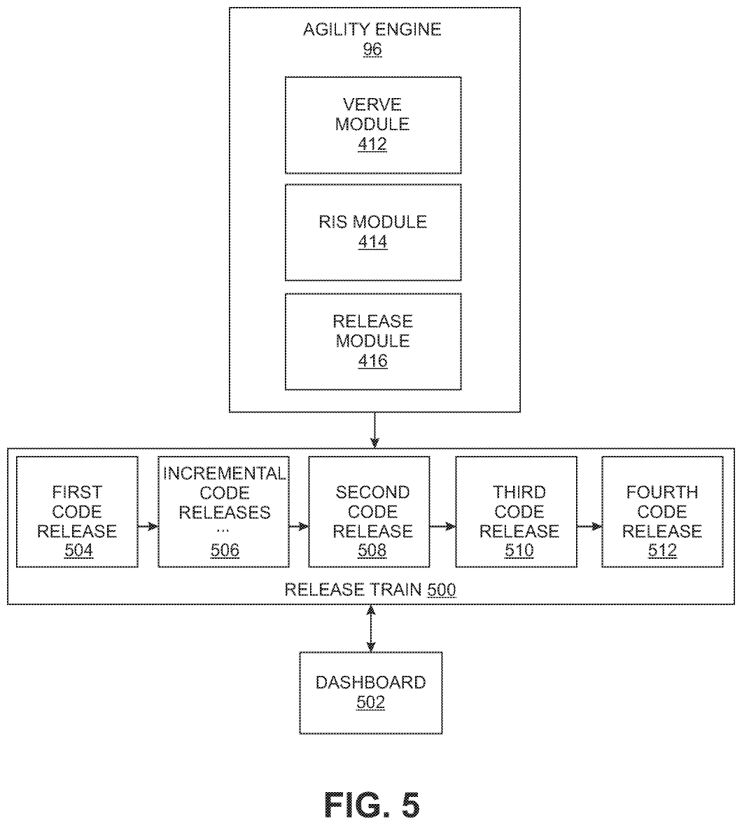

FIG. 5 shows a flowchart of an exemplary method in accordance with aspects of the present invention. Steps of the method may be carried out in the environment of FIG. 4 and are described with reference to elements depicted in FIG. 4. The system may include release train 500 corresponding to eventual stable release train 410 of FIG. 4, which may facilitate the delivery and deployment of incrementally developed or updated code releases, i.e., features. Code releases may include a first code release 504, incremental code releases . . . 506 indicating incrementally developed or updated code releases, and current releases, second code release 508, third code release 510, and fourth code release 512, which may be final or the most current code releases. In embodiments, and as described with respect to FIG. 4, the release module 416 may facilitate the arrangement of the first code release 504, incremental code release(s) “ . . . ” 506 indicating incrementally developed or updated code releases, and current releases, second code release 508, third code release 510, and fourth code release 512 within the release train 500 displayed or communicated via dashboard 502, which may be a user interface indicating releases arranged on the release train 500. Release train 500 may correspond to stable release train 410 of FIG. 4 once each of the first code release 504, incremental code release(s) “ . . . ” 506 indicating incrementally developed or updated code releases, and current releases, second code release 508, third code release 510, and fourth code release 512 are stabilized based on the verve and the RIS.

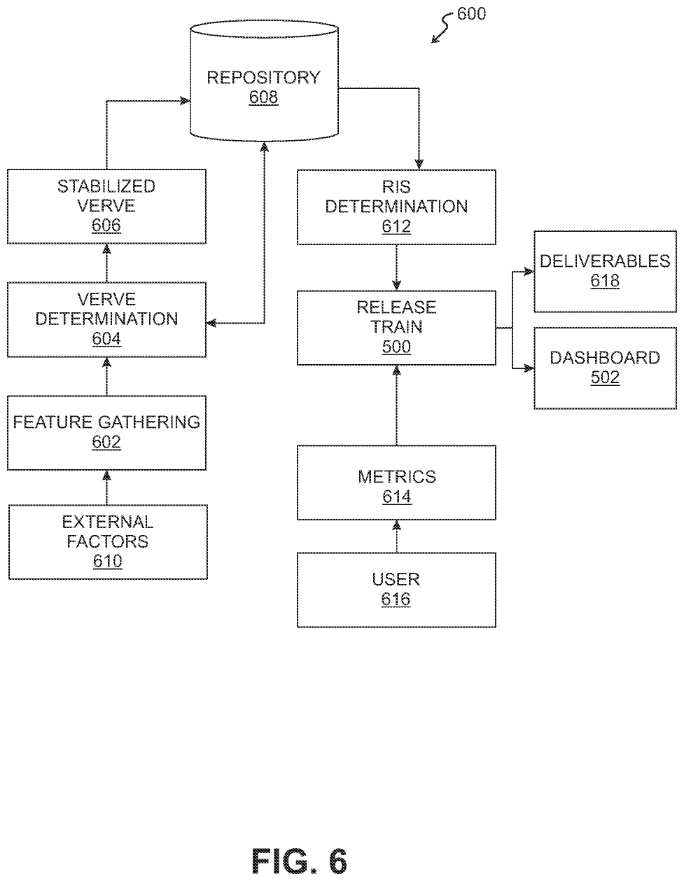

FIG. 6 shows a block diagram of an exemplary system 600 including a verve determination 604 of code releases. In particular, the verve determination 604 may receive external factors 610 such as a release prioritization, a client prioritization, a business prioritization, availability of resource bandwidth and third-party application integration, and release dependency. A verve of a particular code portion, feature, or code release may be determined according to the following equation:

f(x)=a₁x₁+a₂x₂+a₃x₃+ . . . +aₓxₓ
where x=a feature;
a₁ to aₙ=the intensity of each intent; and
x₁ to xₙ=actual intent value ranging from 1-100

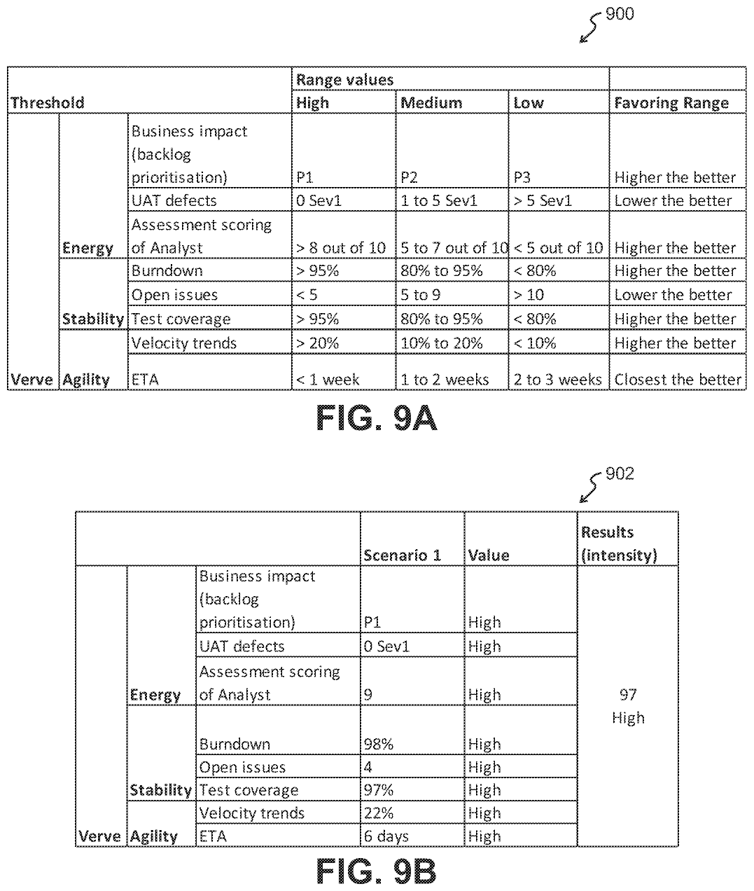

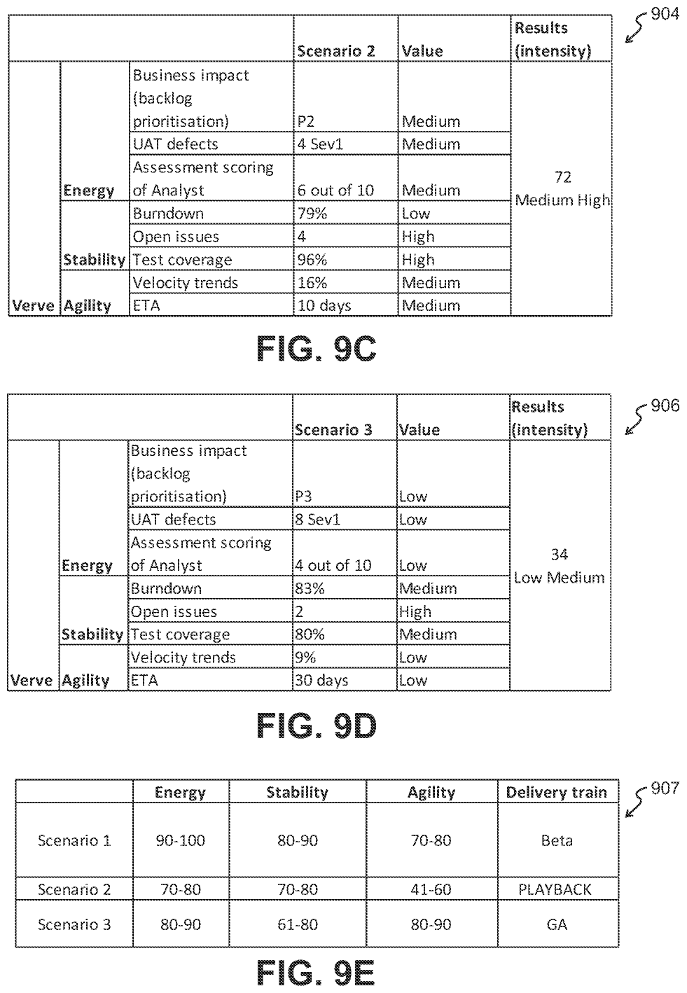

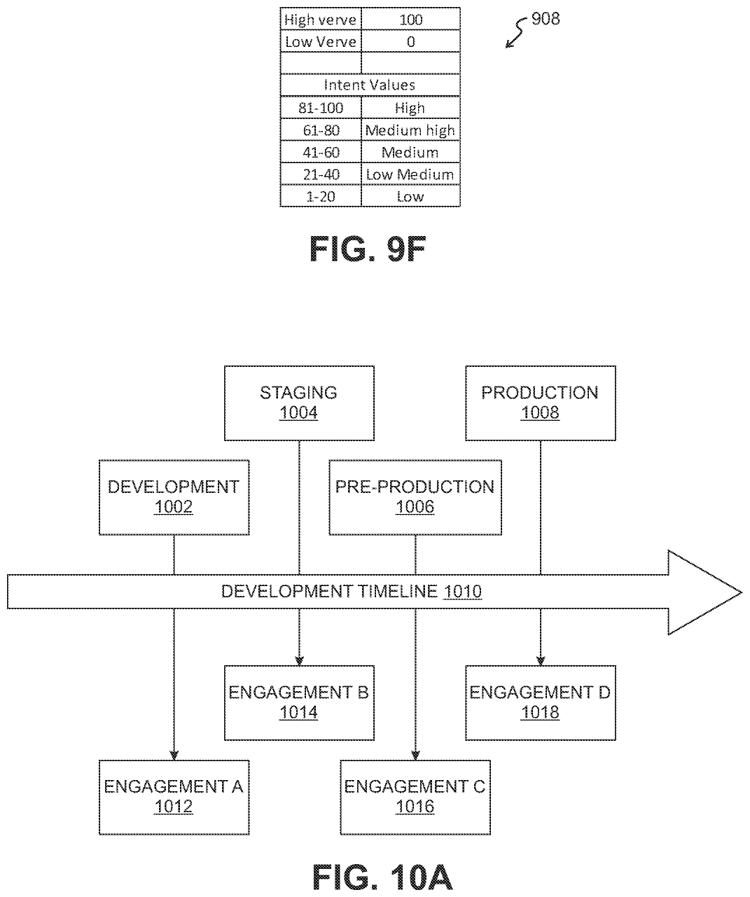

Verve determination 604 may be performed by the verve module 412 of FIG. 4 and may include identifying code release timing, resource availability, completeness of features, as well as its relative importance to the environment in which the features may be being deployed. In embodiments, the total intensity of a feature may be 100 and may be correlated between intents of a feature where intent is the energy, stability, and agility of a feature that makes up verve. In particular, the feature gathering 602 determines the relative importance to the environment in which the features are being deployed. Verve determination 604 may also be depicted in FIGS. 9A and 9B. In embodiments, feature gathering 602 may include receiving external factors 610, such as information relating to required release timing, importance, tools for requirements gathering from a client, client meeting information, audio, and video, or communications including emails and chats, etc. The system 600 may include stabilizing verve 606, performed via the verve module 412 of FIG. 4, which uses information from feature gathering 602 and external factors 610 to supplement a verve with information not included in the data or metadata of a code release. For example, code release information may include data relevant to deployment of code portions or features, but not user-required release timing. Stabilized verve 606 may include supplementing code release information with information from feature gathering 602 and external factors 610. Additionally, stabilizing verve 606 may be based on code release quality, testing, user acceptance testing, time, resources, tasks, security requirements, and market state. Similarly, a release train 500 may be stabilized by releasing code in verve packets and stabilizing a release train or subjecting low-verve code back through the development framework to recalculate verve or RIS. In this manner, verve packets having low-verve, such as the low-verve determination depicted in FIG. 9c, undergo additional verve determinations 604 performed by the verve module 412 of FIG. 4 that may include identifying code release timing, resource availability, completeness of features, as well as its relative importance to the environment in which the features may be being deployed. Code may be packetized in repository 608, including the verve of a code. The verve determination 606 determines the verve of the code. A release intensity scoring (RIS) determination 612 may be performed on code packetized in repository 608 by estimating the required resources, timelines, and features of a code packet and its relative importance within the release train 500. For example, code “AA” may include core features of a computer program but may be dependent on features within code portions “B” and “C.” Therefore, despite the importance of code “AA,” RIS determination 612 may dictate that code portions “B” and “C” should be prioritized over code “AA” in release train 500. In a similar manner, code portions “B” and “C” may be re-arranged on release train 500 based on required resources rather than timing. RIS may be the average or weighted average of features aligned with a release, according to the following equation:

f(v)=f(x₁)+f(x₂)+f(x₃)+ . . . +f(xₙ)
where x₁ to xₙ=the verve score of each feature

RIS determination 612 may be updated over time, which may require real-time re-arrangement of code portions within the release train 500. Additionally, metrics 614 may be used by release module 416 of FIG. 5 to further modify the release train 500 based on system metrics such as web service metrics, code development metrics, client metrics from the user 616, etc. Release train 500 may be communicated and displayed via dashboard 502 of FIG. 4. In particular, the dashboard 502 may include communicating and displaying the release train 500 including deliverables 618 and stabilized code releases.

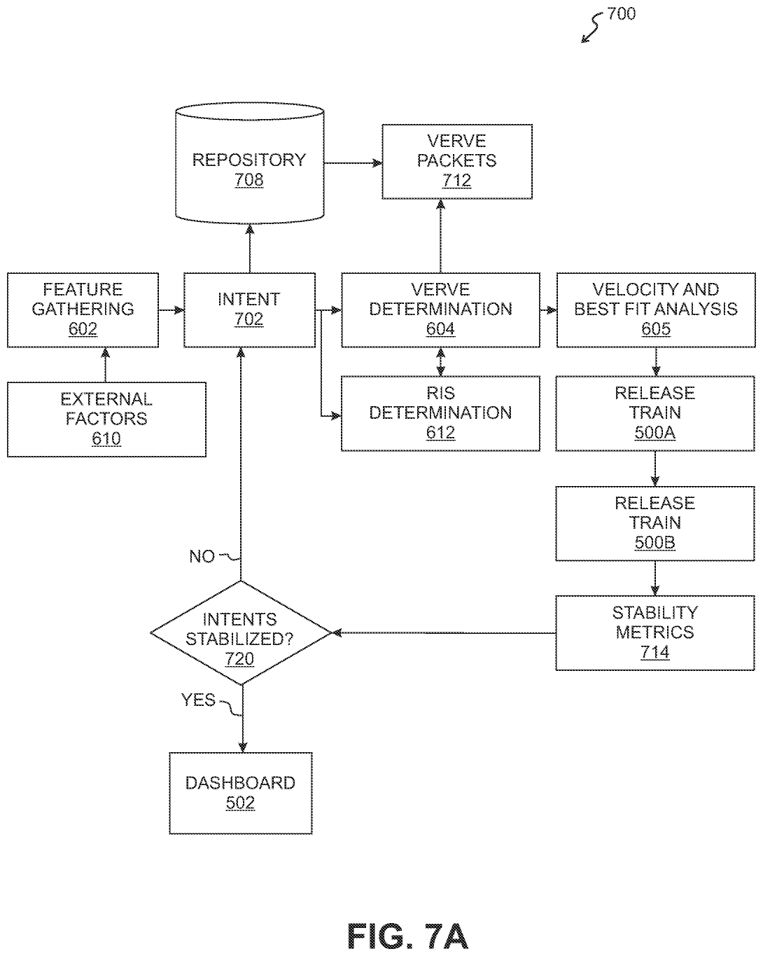

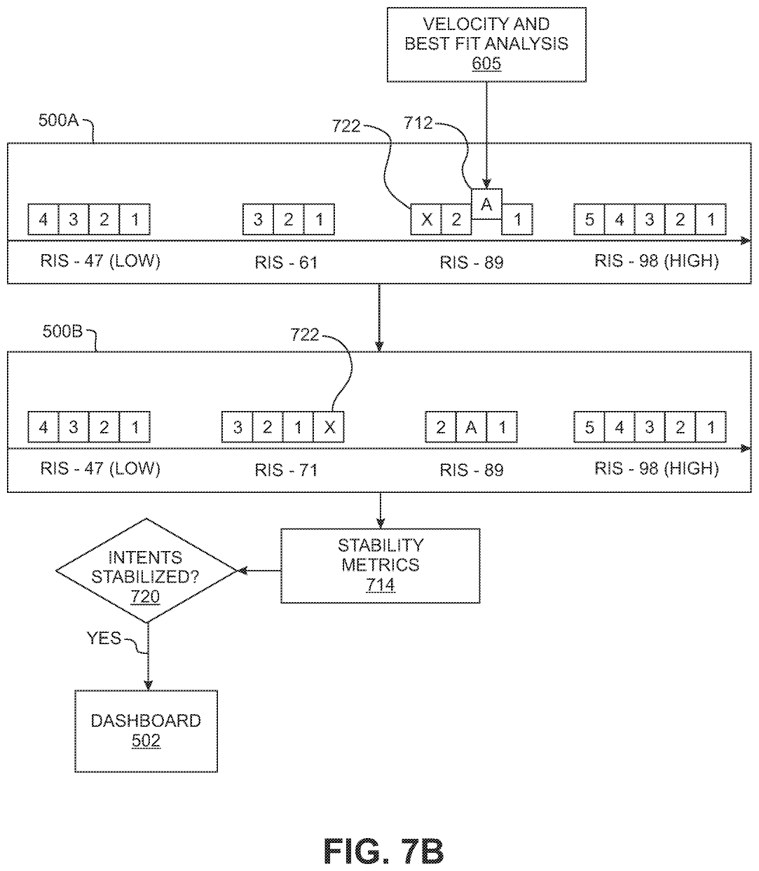

FIG. 7A shows a block diagram of an exemplary system 700 including identifying code feature intent 702 based on feature gathering 602 of FIG. 6. The feature gathering 602 may include receiving external factors 610, such as information relating to required release timing, importance, tools for requirements gathering from a client, client meeting information, audio, and video, or communications including emails and chats, etc. Intent 702 may be the energy, stability, and agility of a feature that makes up verve. Intent 702 may include an intensity as indicated above i.e. a₁ to aₙ, and may include determining an intensity of each intent via natural language processing. Intensity may be based on feature assessment scores and velocity trends and may be converted to a range of numbers used during verve determination 604. The range of numbers for each intent may be evenly distributed e.g. ten intents may each hold ten spaces within a range from 1-100. Feature energy may consider business impact, user acceptance testing defects, and assessment scoring of analysis of a feature. Feature stability may consider burndown, open issues, and test coverage of a feature. Feature agility may consider velocity trends and the estimated time of arrival (ETA) of a feature. Intent 702 may include desired code release features and development requirements which may be stored in repository 708. Intent 702 may be a 610 range of numbers utilized by the RIS module 414 and verve module 412 of FIG. 4 to perform RIS determination 612 and verve determination 604, respectively. RIS determination 612 may be performed via RIS module 414 of FIG. 4, including intent 702 and feature details retrieved from the repository 708 to generate verve packets 712. The verve packets 712 includes code packetized in repository 608 of FIG. 6. RIS determination 612 may include scoring release intensity based on verve and importance, such as on a scale from 1-100. RIS determination 612 may be attached to verve packets 712. Release module 416 of FIG. 4 may perform release velocity and best fit analysis 605 based on RIS and verve of verve packets 712 and position verve packets 712 within release train 500A. For example, a verve packet 712 having a verve of 75 would be positioned within a release train having a similar or matching RIS e.g., 61-80. Additionally, RIS determination 612 may be performed via RIS module 414 of FIG. 4 on groups of verve packets 712 having a similar RIS. Further, RIS determination 612 may be performed on all verve packets 712 within release train 500A to determine RIS for an entire release train. Verve packets 712 within release train 500A may be re-ordered or re-arranged based on RIS or based on the addition of new verve packets 712 to create an updated release train 500B. For example, release train 500A may be updated based on the calculation and recalculation of the verve of verve packets 712 or updated RIS calculation, to form release train 500B. Further, release train 500B includes verve packets 712 in a different release order than the same features as arranged in release train 500A. Release train 500A or 500B, each separately correlating to release train 500 of FIG. 4, may be continuously re-ordered based on verve packets 712, verve, and RIS. Additionally, stability metrics 714 of a release train 500, such as burn down, open issues, user acceptance testing, etc., may be determined and used to update intent 702 and RIS determination 612 and verve determination 604 of future or updated release trains. If intents are stabilized 720 and if stability metrics 714 do not affect or modify intent 702, RIS determination 612, and verve determination 604, the release train 500B may be communicated and displayed via dashboard 502 of FIGS. 5 and 6. If intents are not stabilized 720, the system may reprocess verve determinations with intents to re-identify how to position a feature within the release train 500A.

FIG. 7B shows a block diagram of an exemplary system including updating the release train 500A of FIG. 7A based on the calculation and recalculation of the verve of verve packets or updated RIS calculation, to form release train 500B. Release module 416 of FIG. 4 may perform release velocity and best fit analysis 605 based on RIS and verve of verve packets 712 and position verve packets 712 within release train 500A. For example, a verve packet 712 having a verve of 85 may be positioned within a release train having a similar or matching RIS e.g., 81-90. Additionally, RIS determination may be performed via RIS module 414 of FIG. 4 on groups of verve packets 712 having a similar RIS. Further, RIS determination may be performed on all verve packets 712 within release train 500A to determine RIS for an entire release train. Verve packets 712 within release train 500A may be re-ordered or re-arranged based on RIS or based on the addition of new verve packets 712 to create an updated release train 500B. For example, release train 500A may be updated based on the calculation and recalculation of the verve of verve packets 712 or updated RIS calculation, to form release train 500B. Further, release train 500B includes verve packets 712 in a different release order than the same features as arranged in release train 500A. Release train 500A or 500B, each separately correlating to release train 500 of FIG. 4, may be continuously re-ordered 722 based on verve packets 712, verve, and RIS. Additionally, stability metrics 714 of a release train 500B, such as burn down, open issues, user acceptance testing, etc., may be determined and used to update intent, RIS determination, and verve determination of future or updated release trains. If intents are stabilized 720 and if stability metrics 714 do not affect or modify intent, RIS determination, and verve determination, the release train 500B may be communicated and displayed via dashboard 502 of FIGS. 5 and 6. If intents are not stabilized 720, the system may reprocess verve determinations with intents to re-identify how to position a feature within the release train 500A.

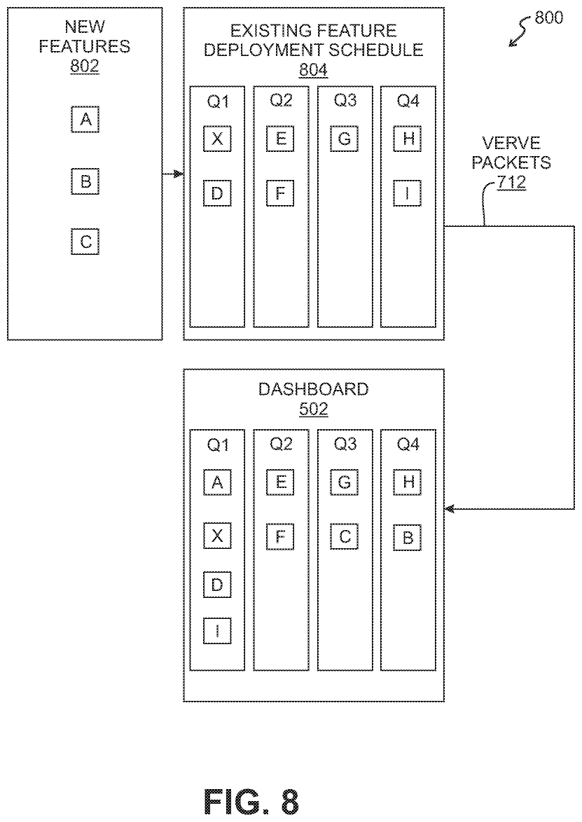

FIG. 8 shows a block diagram of an exemplary system 800, including adding new features 802, i.e., code releases “A,” “B,” and “C” to be deployed into an existing code environment. Existing feature deployment schedule 804 over Q1, Q2, Q3, and Q4 may include a number of existing, pre-planned features such as “X,” “E,” “G,” “H,” etc. New features 802 may undergo RIS determination 612 and verve determination 604 of FIG. 6 via RIS module 414 and verve module 412 of FIG. 4. Verve packets 712 within release train 500A of FIG. 5 may be re-ordered or re-arranged based on verve or RIS or based on the addition of new verve packets 712 to create an updated release train 500B of FIG. 5. Release train 500A or 500B may be continuously re-ordered based on verve packets 712, verve, and RIS. Further, release train 500A or 500B may be communicated to dashboard 502 which depicts a feature deployment schedule having both existing, pre-planned features, and new features 802. For example, features “A,” “B,” and “C” may be integrated into the existing feature deployment schedule 804 based on their co-dependency of function or code, in addition to rearranging the existing feature deployment schedule 804 based on “A,” “B,” and “C.”

FIG. 9A shows a table 900 of an exemplary method for determining a verve of a feature in particular scenarios, such as P1, P2, and P3. In particular, P1, P2, and P3 scenarios are performed by verve module 412 of FIG. 4. The verve may be determined based on features or code intents 702, as in FIG. 7A and FIG. 7B. In particular, the features include energy, stability, and agility. Feature energy may consider business impact, user acceptance testing defects, and assessment scoring of analysis of a feature. Feature stability may consider burndown, open issues, and test coverage of a feature. Feature agility may consider velocity trends and estimated time of arrival (ETA) of a feature.

FIG. 9B shows a table 902 of an exemplary method for determining a verve of a feature in a particular scenario, such as P1. In particular, P1 scenario is performed by verve module 412 of FIG. 4. The verve may be determined based on feature or code intent, energy, stability, and agility. Feature energy may consider business impact, user acceptance testing defects, and assessment scoring of analysis of a feature. Feature stability may consider burndown, open issues, and test coverage of a feature. Feature agility may consider velocity trends and estimated time of arrival ETA of a feature. A verve result may be a numerical score ranging between 0 and 100, e.g., “97,” that may indicate high readiness of a feature.

FIG. 9C shows a table 904 of an exemplary method for determining a verve of a feature in a particular scenario, such as P2. In particular, P2 scenario is performed by verve module 412 of FIG. 4. The verve may be determined based on feature or code intent, energy, stability, and agility. Feature energy may consider business impact, user acceptance testing defects, and assessment scoring of analysis of a feature. Feature stability may consider burndown, open issues, and test coverage of a feature. Feature agility may consider velocity trends and estimated time of arrival ETA of a feature. A verve result may be a numerical score ranging between 0 and 100, e.g., “72,” that may indicate moderate readiness of a feature.

FIG. 9D shows a table 906 of an exemplary method for determining a verve of a feature in a particular scenario, such as P3. In particular, P3 scenario is performed by verve module 412 of FIG. 4. The verve may be determined based on feature or code intent, energy, stability, and agility. Feature energy may consider business impact, user acceptance testing defects, and assessment scoring of analysis of a feature. Feature stability may consider burndown, open issues, and test coverage of a feature. Feature agility may consider velocity trends and estimated time of arrival ETA of a feature. A verve result may be a numerical score ranging between 0 and 100, e.g., “34,” that may indicate low-verve of a feature.

FIG. 9E shows a table 907 of an exemplary method for modifying a release train or delivery train based on the energy, stability, and agility of a feature in a particular scenario, such as scenario 1 (P1), scenario 2 (P2), or scenario 3 (P3) in FIGS. 9A-9D. A release train or delivery train may include a mode of engagement, such as beta or playback demos, and modifying an engagement schedule based on the energy, stability, and agility of a feature.

FIG. 9F shows a table 908 of an exemplary method for determining a verve based, in part, on intent of a feature in a particular scenario, such as scenario 1 (P1), scenario 2 (P2), or scenario 3 (P3) in FIGS. 9A-9D. Further, the intent values of FIGS. 9A-9D are shown in FIG. 9F.

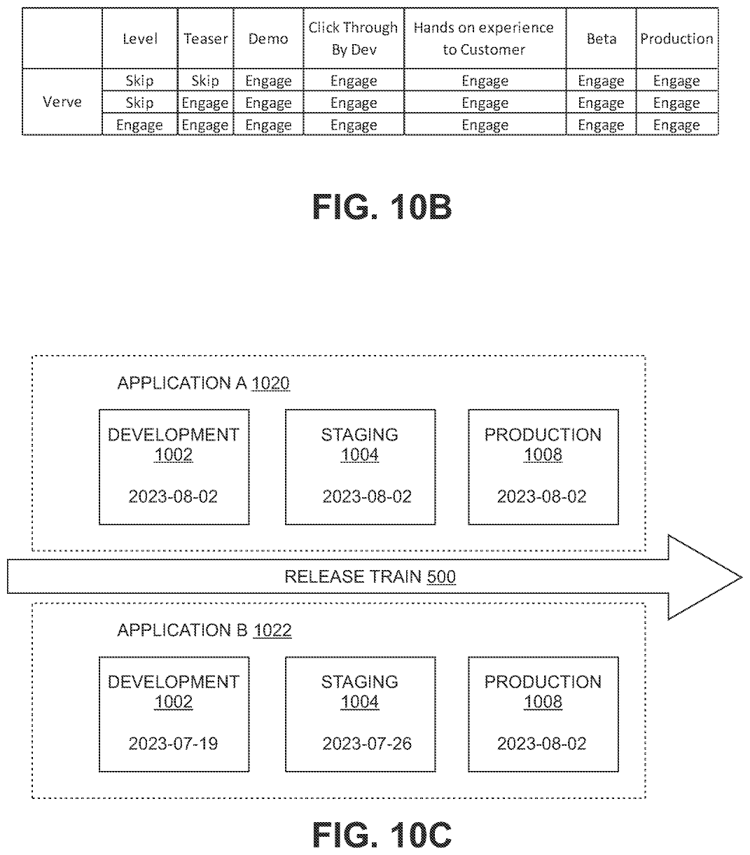

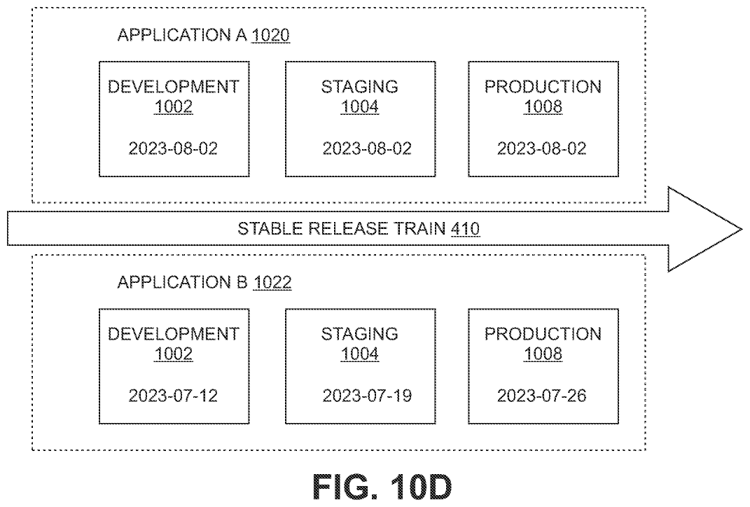

FIG. 10A shows a block diagram of an exemplary environment in accordance with aspects of the present invention including determining a mode of engagement and modifying a development engagement schedule based on a release train. A development timeline 1010, corresponding to the release train 500 of FIG. 5, may include code or features including development 1002 and associated engagement A 1012. Engagements 1012, 1014, 1016, and 1016 may be modes of engagement such as level, teaser, demo, click through by dev, hands on experience to customer, beta, and production. Engagement A 1012 may be, for example, a teaser of an initial prototype of a feature provided to a recipient of the feature in development. Functional verification testing may occur as part of development 1002 prior to staging 1004. Staging 1004 may have an associated engagement B 1014. Engagement B 1014 may be, for example, a click-through demonstration of a feature showing functionality. Feature integration testing may occur prior to moving a feature into pre-production 1006 having corresponding to engagement C 1016. Engagement C 1016 may be, for example, a live click-through of a feature showing functionality in a controlled environment. User acceptance testing and pen testing may occur prior to proceeding to production 1008 including corresponding engagement D 1018. Engagement D 1018 may be, for example, a hands-on experience of the feature in development. Development timeline 1010 may include additional pre-release development staging, steps, etc. In embodiments, the development timeline 1010 may be modified based on verve and RIS, as shown in FIG. 8. For example, skipping engagement A 1012 and engagement B 1014 is based on a high RIS, such that a feature having a high verve may be delivered sooner. In embodiments, the modes of engagement may be modified based on verve, RIS, and the development timeline 1010. As a non-limiting example, certain engagements may be skipped based on a high RIS of a feature, such that a feature having a high verve may be delivered sooner.

FIG. 10B shows a table of an exemplary method for determining a verve of a feature in a particular scenario including modifying an engagement schedule based on the stabilized release train. In particular, FIG. 10B shows a table of engagements such as level, teaser, demo, click through by dev, hands on experience to customer, beta, and production, such as the engagements 1012, 1014, 1016, and 1018 of FIG. 10A. A verve may be gauged and gazed at during pre-release of a feature to determine which modes of engagement that are appropriate for a particular feature. In embodiments, verve may be gauged and gazed at during pre-release of a feature to determine modes of engagement that are appropriate for potential customer bases or sponsored users. As a nonlimiting example, certain engagements may be skipped based on a high RIS of a feature, such that a feature having a high verve may be delivered sooner.

FIG. 10C shows a flowchart of an exemplary use case of modifying an engagement schedule based on the release train 500. For example, application A 1020 may be a consumer application including development 1002 and corresponding target date of delivery, staging 1004 and corresponding target date of delivery, and production 1008 and corresponding target date of delivery. Similarly, application B 1022 may be a producer application including development 1002 and corresponding target date of delivery, staging 1004 and corresponding target date of delivery, and production 1008 and corresponding target date of delivery. However, application A 1020 may have a low verve and application B 1022 may have a high verve, resulting in a mismatch in stabilization between application A 1020 and application B 1022. In some cases, this may result in application A 1020 and application B 1022 having the same code for both a consumer application and a producer application and untested dependencies may exist and be unaddressed.

FIG. 10D shows a flowchart of an exemplary use case of modifying an engagement schedule based on a stable release train 410. For example, application A 1020 may be a consumer application including development 1002 and corresponding target date of delivery, staging 1004 and corresponding target date of delivery, and production 1008 and corresponding target date of delivery. Similarly, application B 1022 may be a producer application including development 1002 and corresponding target date of delivery, staging 1004 and corresponding target date of delivery, and production 1008 and corresponding target date of delivery. However, application A 1020 may have low verve and application B 1022 may have high verve, resulting in a mismatch in stabilization between application A 1020 and application B 1022. The release train of application B 1022 may be stabilized based on the verve and the RIS of the features in application B 1022, including modifying the target dates of delivery for each of development 1002, staging 1004, and production 1008. As a non-limiting example, the engagement schedule of application B 1002 may have a one-week difference compared to that of application A 1020, such that application B 1022, the producer application, is available for use prior to release of application A 1020, the consumer application.

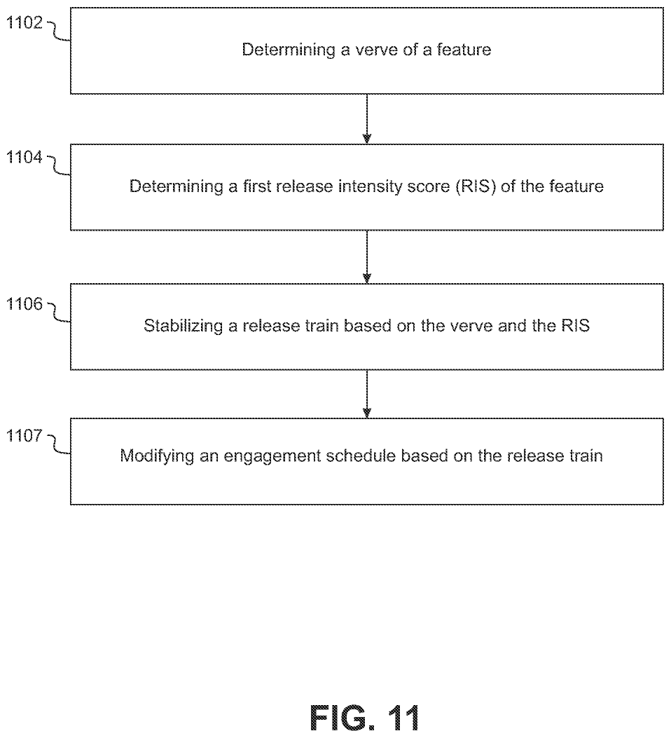

FIG. 11 shows a flowchart of an exemplary method in accordance with aspects of the invention. According to step 1102, the method may include determining a verve of a feature via the verve module 412 of FIG. 4. According to step 1104, the method may include determining a first release intensity score (RIS) of the feature via the RIS module 414 of FIG. 4. According to step 1106, the method may include stabilizing a release train based on the verve and the RIS via the verve module 412 and the RIS module 414 of FIG. 4. According to step 1108, the method may include modifying an engagement schedule based on the release train via the release module 416 of FIG. 4.

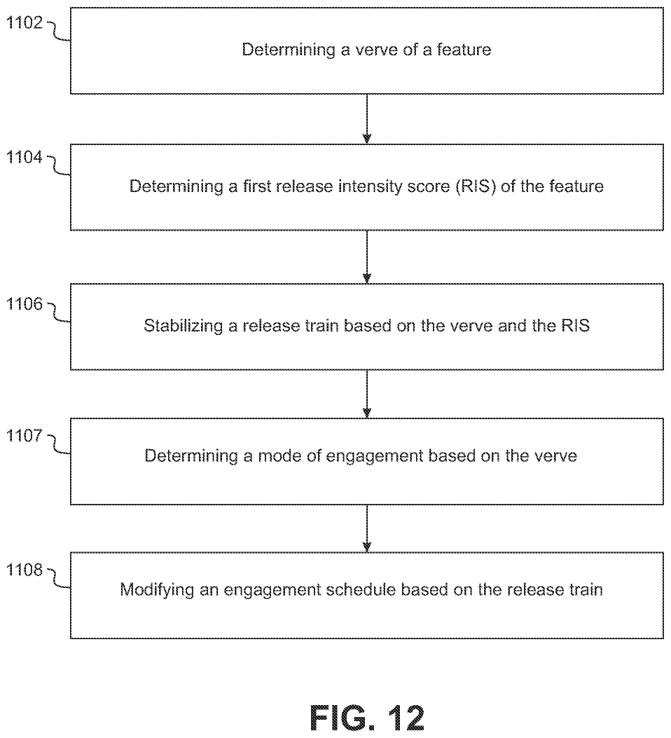

FIG. 12 shows a flowchart of an exemplary method in accordance with aspects of the invention. According to step 1102, the method may include determining a verve of a feature via the verve module 412 of FIG. 4. According to step 1104, the method may include determining a first release intensity score (RIS) of the feature via the RIS module 414 of FIG. 4. According to step 1106, the method may include stabilizing a release train based on the verve and the RIS via the verve module 412 and the RIS module 414 of FIG. 4. According to step 1107, the method may include determining a mode of engagement based on the verve, such as via gauging and gazing the verve to determine which are appropriate for a particular feature as in FIG. 10B. Step 1107 may be performed via the release module 416 of FIG. 4. According to step 1108, the method may include modifying an engagement schedule based on the release train via the release module 416 of FIG. 4.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining, by a computing device, a verve of a feature;
determining, by the computing device, a first release intensity score (RIS) of the feature;
stabilizing, by the computing device, a release train based on the verve and the RIS of the feature; and
modifying, by the computing device, an engagement schedule based on the stabilized release train.

2. The method of claim 1, further comprising packetizing the feature, the verve, and the RIS.

3. The method of claim 1, wherein the determining the RIS comprises estimating the required resources, timelines, and features of a code packet and a relative importance of the code packet within the release train.

4. The method of claim 1, further comprising continuously updating the RIS and rearranging the feature within the release train based on an updated RIS.

5. The method of claim 1, further comprising generating a dashboard displaying the release train.

6. The method of claim 1, further comprising generating a user interface element indicating the verve of a plurality of code packets in the release train.

7. The method of claim 1, further comprising subjecting a low-verve code packet back through a development framework to determine an updated verve.

8. The method of claim 1, further comprising re-ordering the release train based on the verve and the RIS of the feature.

9. The method of claim 1, further comprising modifying a development timeline based on the verve and the RIS of the feature.

10. The method of claim 1, further comprising determining a second RIS of the release train.

11. The method of claim 10, further comprising rearranging the feature within the release train based on the second RIS of the release train.

12. The method of claim 1, wherein the computing device includes software provided as a service in a cloud environment.

13. A computer program product comprising one or more computer readable storage media having program instructions collectively stored on the one or more computer readable storage media, the program instructions executable to:
determine a verve of a feature;
determine a first release intensity score (RIS) of the feature;
stabilize a release train based on the verve and the RIS of the feature; and
determine a mode of engagement and an engagement schedule based on the stabilized release train.

14. The computer program product of claim 13, wherein the program instructions are executable to packetize the feature, the verve, and the RIS.

15. The computer program product of claim 13, wherein the determining the RIS comprises estimating the required resources, timelines, and features of a code packet and a relative importance of the code packet within the release train.

16. The computer program product of claim 13, wherein the program instructions are executable to continuously update the RIS and rearrange the feature within the release train based on an updated RIS.

17. The computer program product of claim 13, wherein the program instructions are executable to generate a dashboard displaying the release train.

18. The computer program product of claim 13, wherein the program instructions are executable to generate a user interface element indicating the verve of a plurality of code packets in the release train.

19. The computer program product of claim 13, wherein the program instructions are executable to re-order the release train based on the verve and the RIS of the feature.

20. A system comprising:
a processor, a computer readable memory, one or more computer readable storage media, and program instructions collectively stored on the one or more computer readable storage media, the program instructions executable to:
determine a verve of a feature;
determine a first release intensity score (RIS) of the feature;
stabilize a release train based on the verve and the RIS of the feature; and
modify an engagement schedule based on the stabilized release train.
